(19) United States
(12) Patent Application Publication
(10) Pub. No.: US 2005/0164152 A1
(43) Pub. Date: Jul. 28, 2005

(54) Compatibility assessment method

(76) Inventor: James Donald Lawson, Rocky River, OH (US)

Correspondence Address: JAMES DONALD LAWSON, 20325 CENTER RIDGE RD., SUITE 740, ROCKY RIVER, OH, 44116, US

(21) Appl. No.: 10/766,342

(22) Filed: Jan. 28, 2004

(51) Int. Cl. G09B 3/00

(52) U.S. Cl. 434/322

(57) ABSTRACT

A unique method for determining compatibility between people who, in the preferred embodiment, utilize an interactive internet dating service. Users complete a compatibility questionnaire, first describing themselves and then describing their “ideal match” on questionnaire items whose response options vary between two extremes. The user defines a search based upon demographic information for an “ideal match.” The pool of completed self assessment questionnaires of current users is searched by the computer utilizing the search parameters defined by the user. Pearson correlation coefficients are computed upon the items in the users “ideal match” questionnaire and the pool of self assessment questionnaires defined by the search. The “ideal matches” are ranked and reported as percentile scores that are obtained from a norm group of correlation coefficients for each gender. Percentile scores are also reported in similar manner for each content scale of the compatibility questionnaire. The user is able to search for an “ideal match” utilizing separate content scales from the compatibility questionnaire as well as with combinations of content scales from the questionnaire.

### CROSS REFERENCE TO RELATED APPLICATIONS

Not Applicable

### REFERENCED BY

| | | | |
|---|---|---|---|
| 4216594 | August, 1980 | Farley, et al. | 434/236 |
| 5702253 | December, 1997 | Bryce, et al. | 434/236 |
| 5775695 | July, 1998 | Byers | 273/161 |
| 5913212 | June, 1999 | Sutcliffe, et al. | 707/6 |
| 5963951 | October, 1999 | Collins | 707/102 |
| 6061681 | May, 2000 | Collins | 707/5 |
| 6243375 | June, 2001 | Speicher | 370/352 |
| 6282515 | August, 2001 | Speicher | 705/14 |
| 6421433 | July, 2002 | Arsenault | 379/114.19 |
| 6504920 | January, 2003 | Okon, et al. | 379/121.01 |
| 6594502 | July, 2003 | Koester | 455/414.1 |
| 6665389 | December, 2003 | Haste, III | 379/196 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

The invention is in the field of procedures for psychological testing. The invention further relates to the fields of internet dating services and compatibility matching. More specifically, the invention is a psychological testing procedure designed to facilitate the ability for one individual to find other individuals with whom he or she is most compatible in terms of personality, needs, beliefs, values and behavior while utilizing an internet dating service.

Matchmaking is an age old endeavor that seeks to match individuals who are compatible for the purposes of dating and marriage. The prior art can be characterized as two different methodologies. It has consisted of individuals who were interested in being paired, usually for the purpose of marriage, relying upon an expert person skilled in matching persons of similar backgrounds and goals with one another. On the other extreme, individuals were also free to act as their own experts and to pursue other individuals who they perceived to be compatible choices on their own.

With the advent of the electronic age, individuals who were searching for matches were able to place personal ads in voice message systems, newspapers, on cable television, and more recently with internet dating services. This has been a great advance because it has allowed individuals to obtain greater exposure and to more efficiently search for compatible matches than in the past.

Professional matchmaking has also migrated to internet dating sites. Compatibility matches were initially astrological in origin, and admittedly, more for entertainment than meant as a credible method of matching persons. Compatibility matching more recently has been greatly advanced with the use of psychological tests to match individuals based upon compatibility.

Psychological testing is a common practice to identify patterns of personality, needs, aptitudes, beliefs, values and behaviors descriptive of individuals. Testing is used for a variety of purposes including to provide feedback to the individual test taker in order to increase self awareness. By increasing self awareness the feedback helps the test taker to use more relevant information to make informed choices.

Psychological testing has also been used to provide information to individuals pertaining to compatibility. The prior art has utilized psychological compatibility tests that contain content scales with an accepted degree of statistical internal consistency, or reliability. Individual scores can be obtained for the content scales of the compatibility questionnaire and matched for degree of similarity with the content scales of compatibility questionnaires completed by other individuals to obtain a compatible match.

Internet dating sites that utilize compatibility tests traditionally provide feedback to the individual test taker regarding his or her personality, beliefs, values and behaviors. These sites also often advise individuals using their sites that “experts” have constructed their compatibility tests and that their computer searches are more capable of finding suitable compatibility matches than the individual user would be able to on his or her own behalf. “Expert” information is therefore provided to the individual test taker about other individuals with whom they are most likely to be compatible.

The traditional methodology of compatibility assessment has several limitations. The first limitation is that the message is often communicated to the user of the service that she or he is less capable than experts to find their best match, or “soul mate.” The second limitation is that a message is communicated to users that they lack a sufficient degree of self awareness to have knowledge of what they are looking for in a compatible other person. The third limitation is that the content scales that comprise current compatibility tests are weighted by the “expert” in terms of their importance for all individuals taking the compatibility test, rather than individual users being allowed to prioritize the importance of each content area of compatibility for him or herself. A fourth limitation is that users are not provided the methodology to adequately describe themselves to others. A fifth limitation is that compatibility is primarily determined by degree of similarity between two individuals. A sixth limitation is that users are not provided an efficient procedure to search for compatible other persons on their own.

The prior art has also relied upon utilizing personal ads on internet dating services to assist individuals in locating other individuals with whom they may be attracted. Personal ads that utilize keyword descriptors as well as narrative self descriptions of personality, beliefs, values and behavior have been used to describe oneself and to describe the individual to whom one is attracted. Personal photographs, videos and voice recordings have also been used to communicate on internet dating sites utilizing personal ads in order to attempt to find a compatible match.

The prior art also has several limitations as well. The first limitation is that personal photographs, videos, voice recordings, keyword descriptors and personal narratives do not adequately communicate enough information to determine with whom one is most likely to be compatible. A second limitation is that individuals are not provided a methodology to adequately describe themselves to others. A third limitation is that they are not provided an efficient procedure to search for compatible others on their own.

### BRIEF SUMMARY OF THE INVENTION

The present invention addresses the limitations of the prior arts of compatibility testing and internet dating services. The present invention addresses the limitations of traditional internet dating sites that use compatibility testing to match individuals and traditional internet sites that utilize personal ad site type information such as keyword, narrative and photograph data. The present invention enhances the arts of compatibility assessment and of internet dating services.

An objective of the invention is to provide a methodology for individuals who have a sufficient degree of self awareness to a) describe their personality, needs, beliefs, values and behavior patterns to a large pool of others who are also searching for a compatible other person, and, b) for individuals who have a sufficient degree of self awareness, to describe the personality, needs, beliefs, values and behavior patterns of individuals they consider to be their “ideal match.” This objective assumes that only some individuals have the degree of self awareness necessary to accomplish these tasks, but that others may be helped more by traditional compatibility testing initially. Traditional compatibility testing may help individuals gain a sufficient degree of self awareness so that they may at a later date be more helped by the methodology of compatibility assessment described herein.

An objective of the invention is to allow individuals to place different weights on different components of compatibility, rather than to have the different content scales of a compatibility test weighted by an “expert” who constructed the test. The assumption inherent in this objective is that individuals differ in the importance they place upon different components of compatibility. They differ because they have different life histories and different biological substrates. The present invention provides a methodology for the individual user to evaluate the different components of compatibility that are represented in a compatibility questionnaire, and to differentially weigh the separate components of compatibility in her or his decision making process.

An objective of the invention is to provide a methodology for individuals to communicate an adequate amount of relevant information regarding compatibility when describing themselves to others, and to be have access to an adequate amount of relevant information while searching for compatible others. The assumption of this objective is that the prior arts of personal ads and compatibility assessment utilized by internet dating services do not adequately allow a methodology for the communication of an adequate amount of relevant information regarding compatibility.

Another objective of the invention is to provide a methodology for individuals to describe both their similarities and their differences in a non-impressionistic manner. The assumption of this objective is that individuals search for compatible others who are both similar to themselves but also different from themselves in important ways. The present invention provides a methodology to communicate similarities and differences in their personality, needs, beliefs, values, and behavior patterns in a psychologically meaningful manner.

A final objective is to provide a methodology that users can utilize to efficiently search on their own for individuals with whom they are compatible. They are also provided with information with which to judge the degree of credibility to place in each of their searches.

### BRIEF DESCRIPTION OF THE SEVERAL VIEWS OF THE DRAWING

Not applicable

### DETAILED DESCRIPTION OF THE INVENTION

In the following description, for the purpose of explanation and not limitation, details are provided in order to provide a thorough understanding of the present invention. However, it will be apparent to one skilled in the art that the present invention may be practiced in other embodiments that depart from these specific details. In other instances, detailed descriptions of well-known methods and devices are omitted.

The preferred embodiment of the present invention is an interactive dating site on the internet. However, this is not a limitation of the invention, and the system could be implemented in other ways. Prospective members could submit personal information and complete a psychological questionnaire by mail. They could then receive feedback via the mail, the internet, or telephone regarding how to contact members that their search criteria has determined to be their “ideal match.”

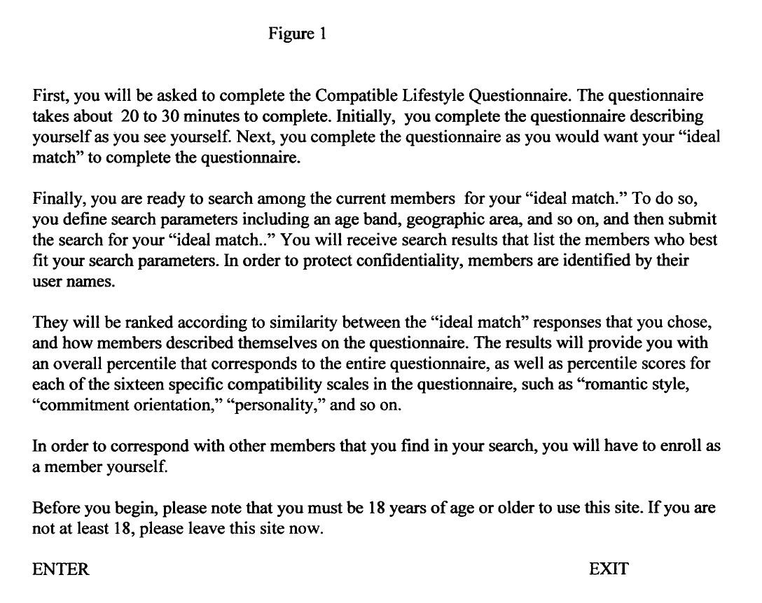

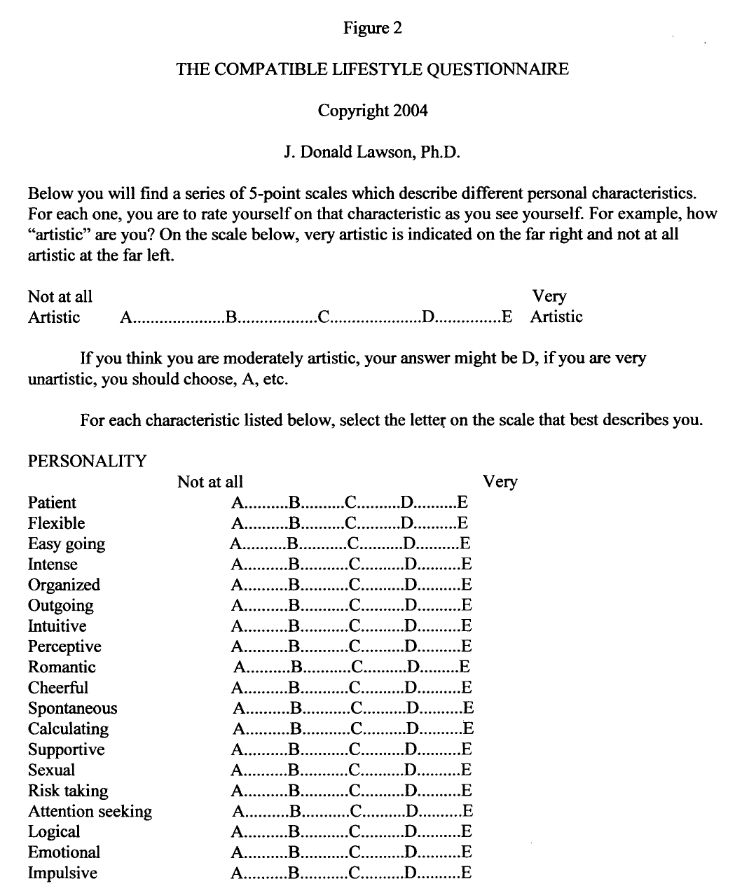

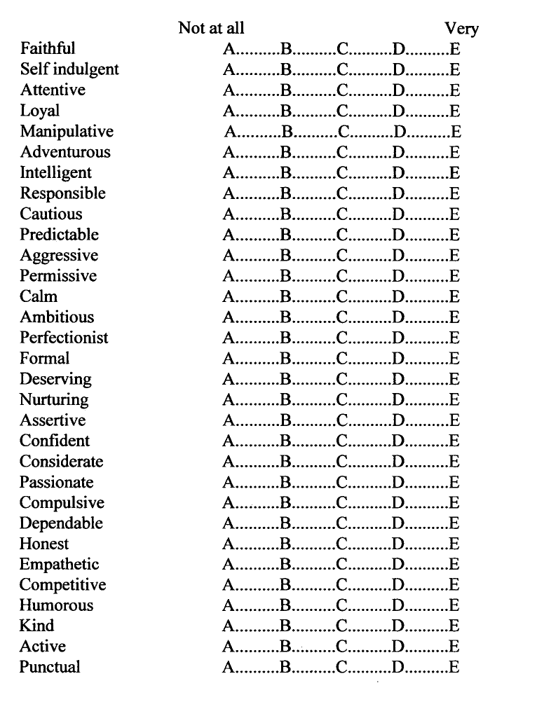

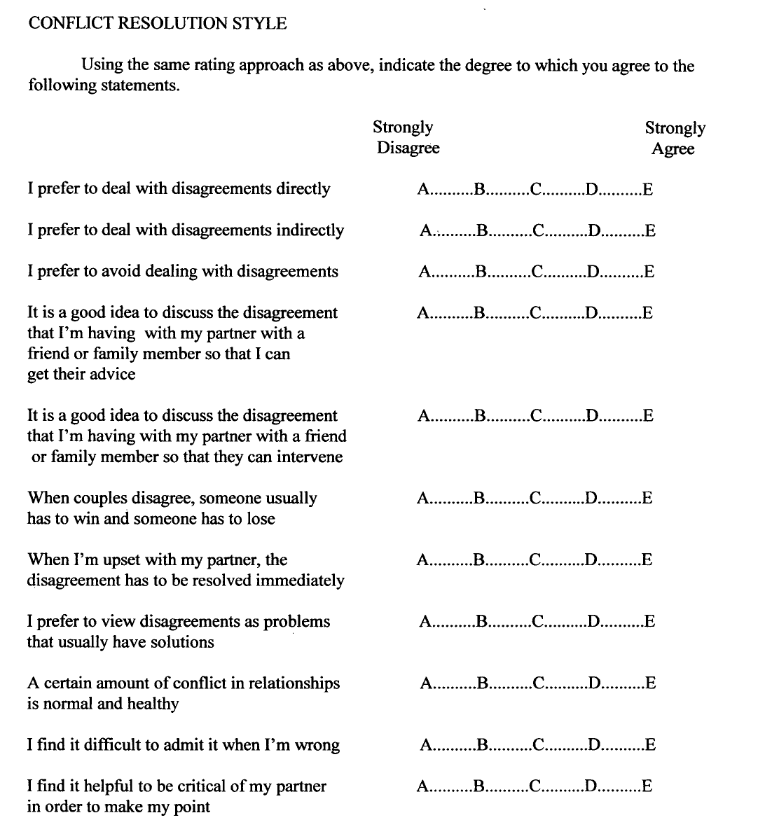

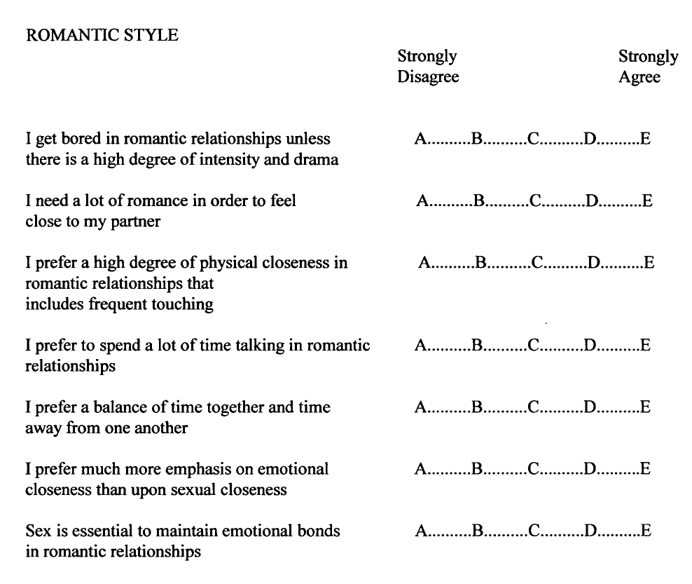

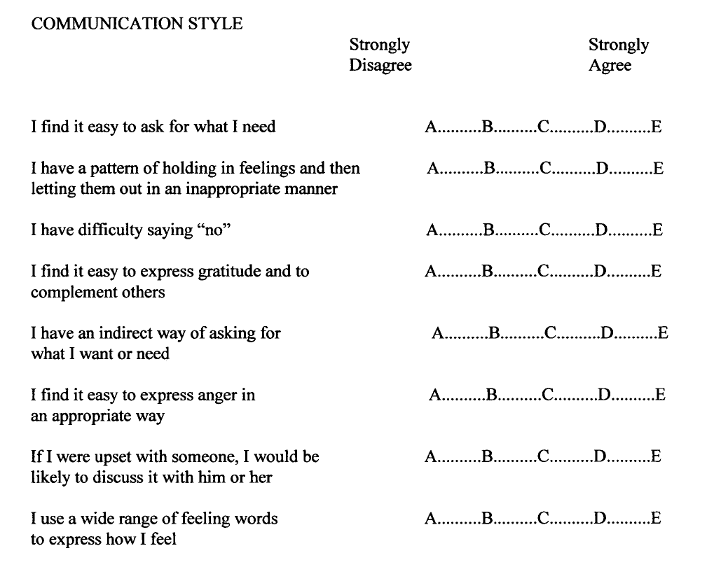

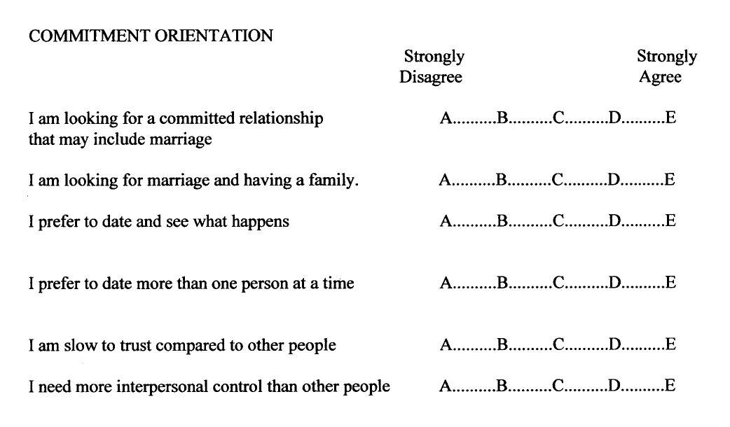

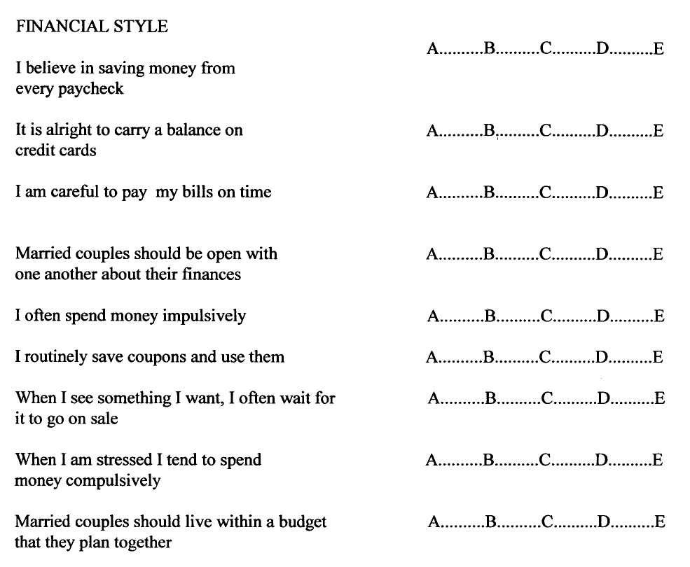

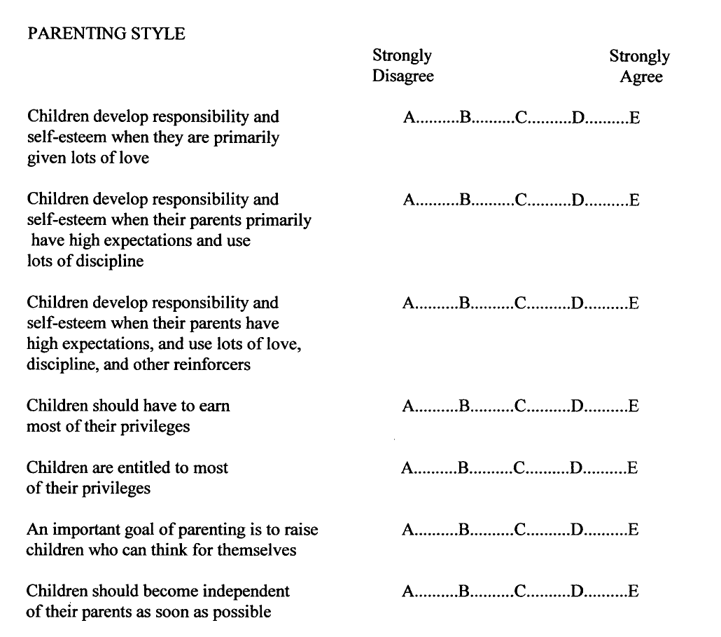

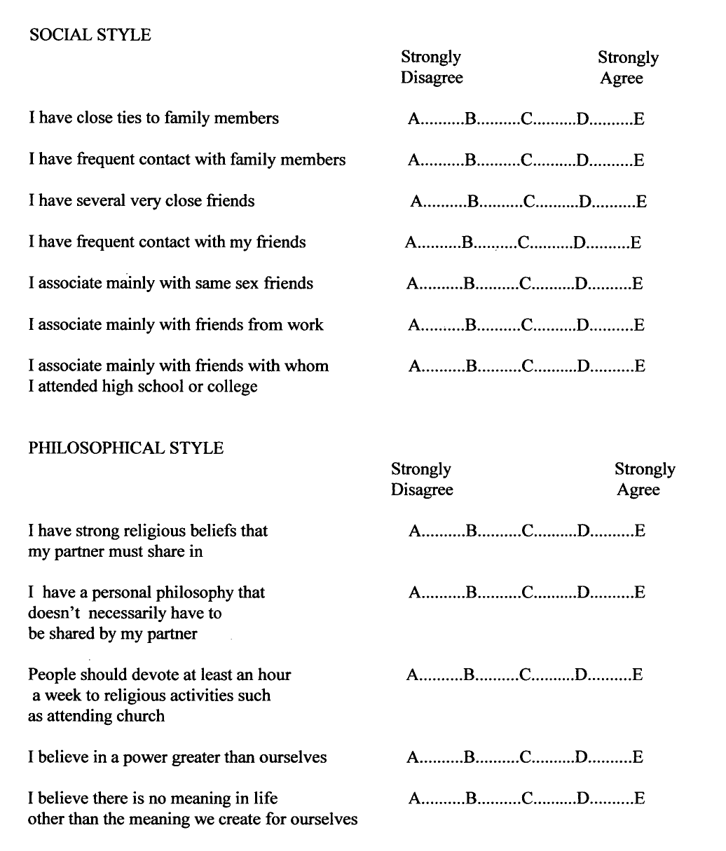

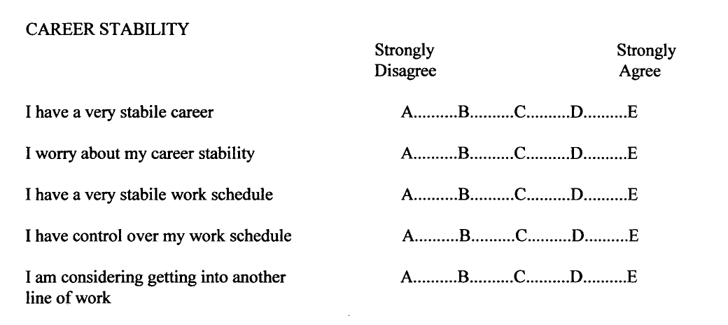

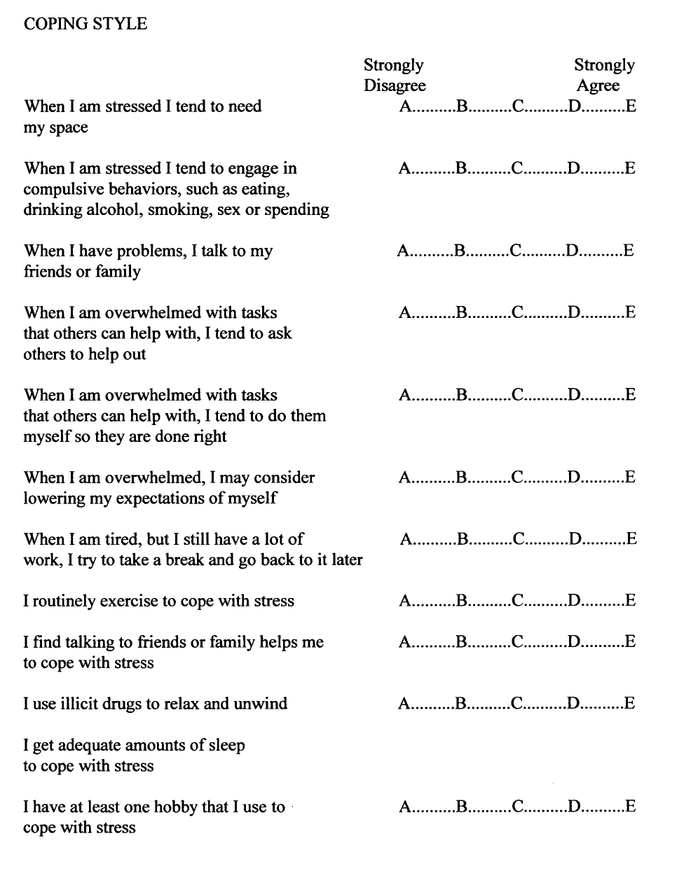

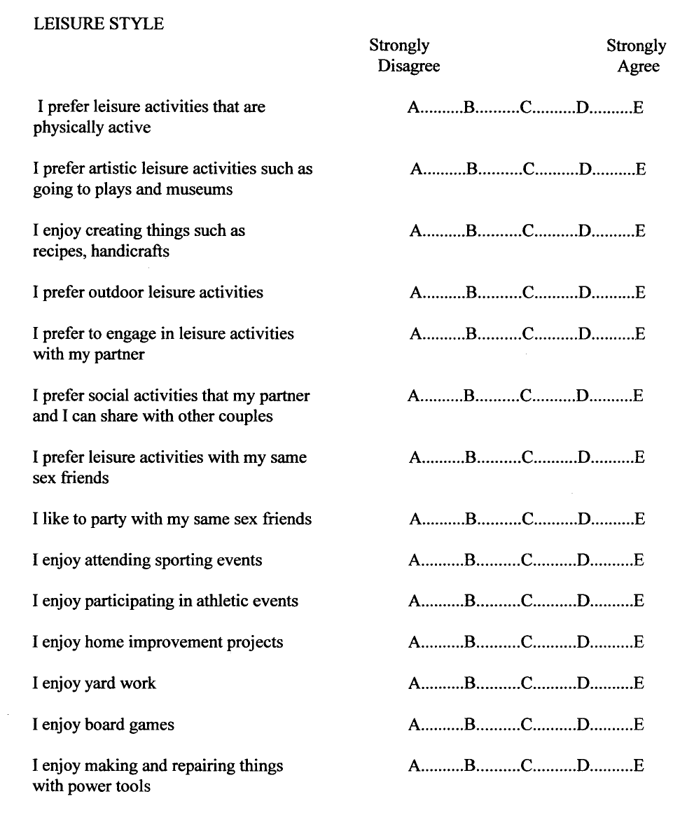

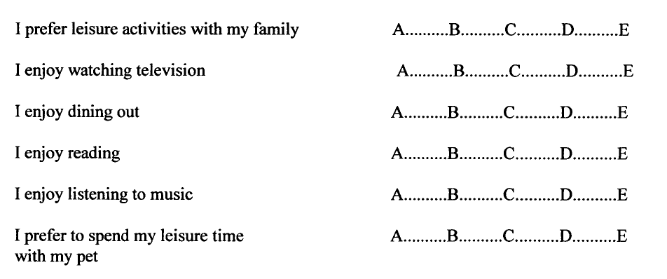

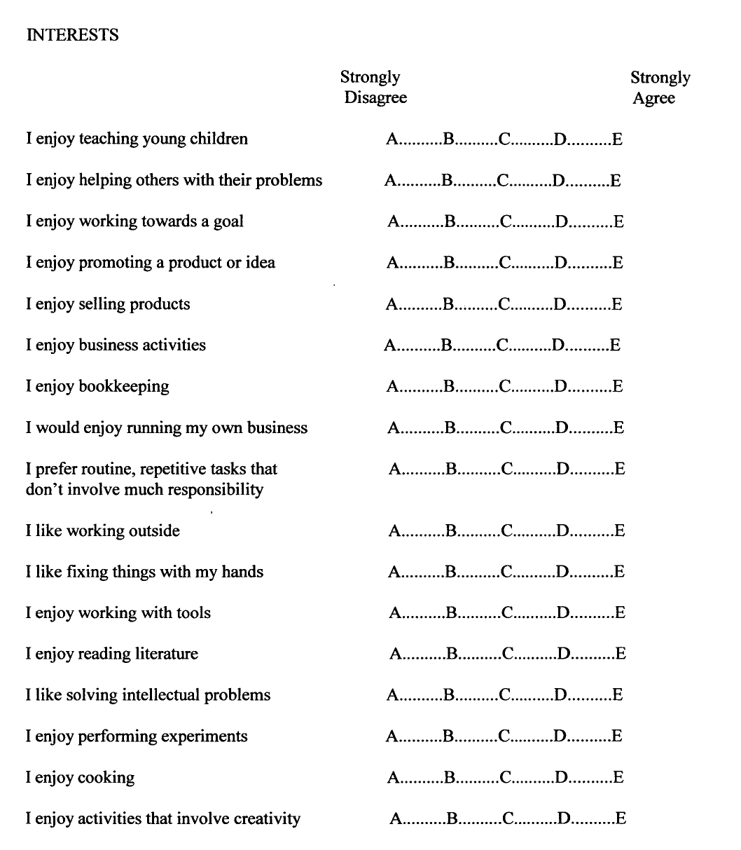

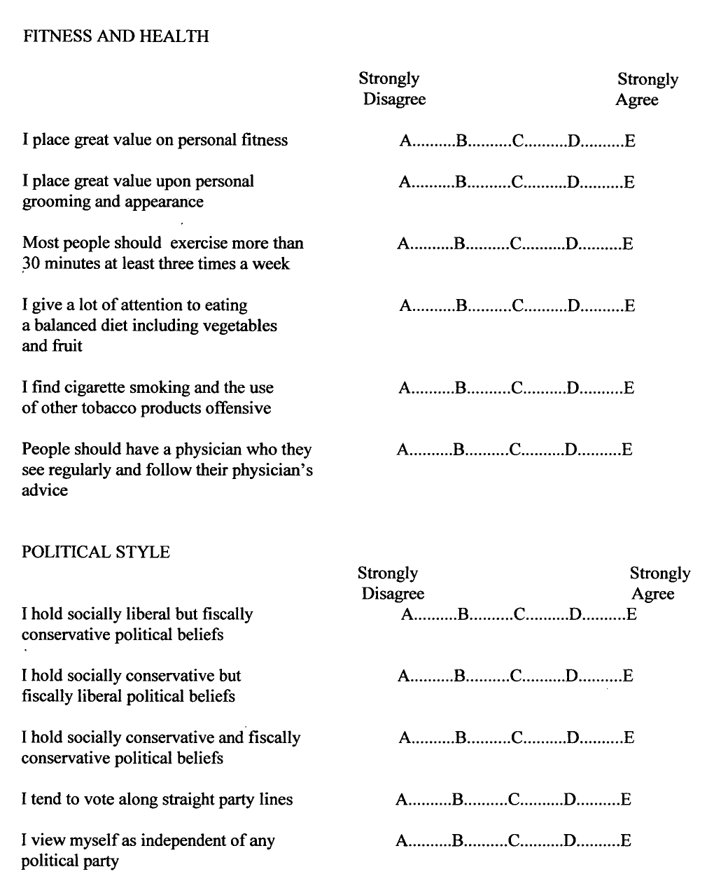

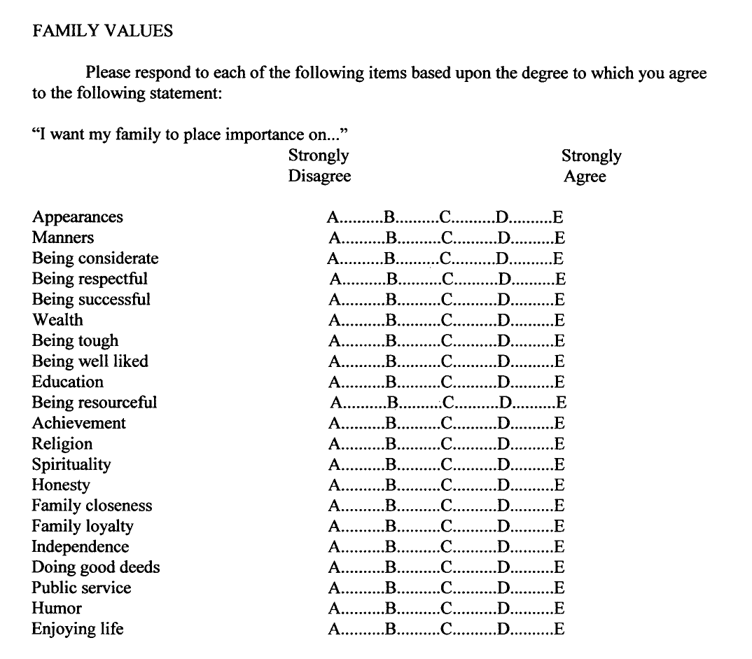

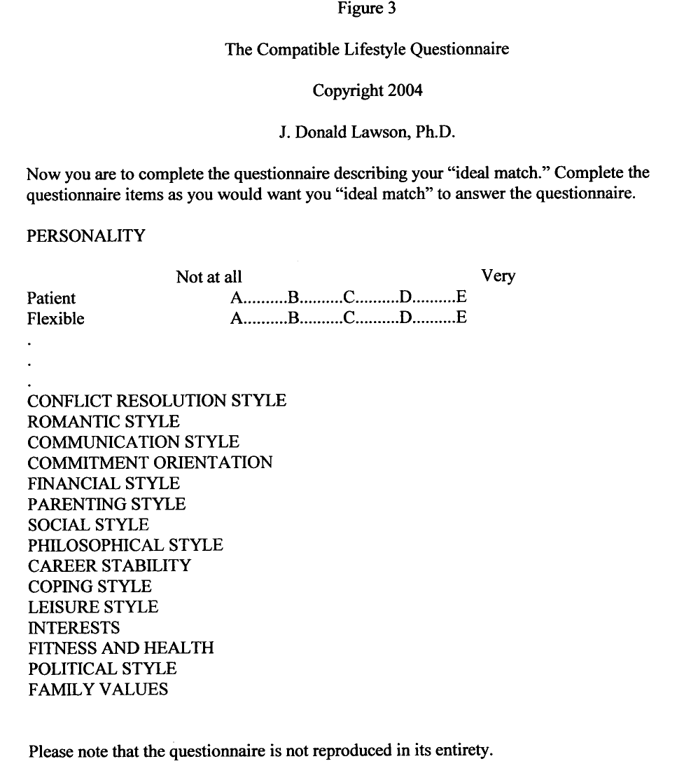

As an interactive internet dating site, prospective members would be informed regarding the nature of the service. (See FIG. 1). As a security measure, they would provide credit card information regarding themselves in order to assist in verifying their age and identity. They would then be free to complete a compatibility questionnaire (See FIG. 2), first describing themselves and then describing their “ideal match” (See FIG. 3).

Individuals are asked to describe themselves as well as their “ideal match” on questionnaire items that vary between two extreme responses, such as “not at all” to “very,” and “strongly disagree” to “strongly agree” (See FIGS. 2 and 3). In the preferred embodiment individuals are able to choose from five response options that utilize intervals that are of equal psychological distance from one another. Users are therefore able to provide information regarding their similarities and differences in a psychologically meaningful manner.

A pattern of differences and similarities could also be obtained by offering only two response options, such as “yes” or “no,” to questionnaire items. However, to do so would detract from the individual's opportunity to adequately differentiate his or herself, and his or her “ideal match,” through his or her pattern of responses. It should be understood by those skilled in the art that utilizing two response options does not, however, depart from the spirit and scope of the present invention.

After completing the questionnaire, users would then define a search based upon criteria of their choosing, including but not limited to an age range, gender, and geographic location. For example, a 35 year old female might choose to specify a search for men who are between the ages of 30 to 35, who are college educated, and live within 25 miles of her.

Search results would be presented in a format that presents user names corresponding to the individuals who completed the self description in the questionnaire database. User names would be listed in rank order from highest to lowest percentiles (See Table 1) for a specified number of users, which may be five, but is not limited to five. The number of questionnaires and corresponding users considered in the search for the “ideal match” would be reported to the user. Percentile scores would also be reported for the five users, or “ideal matches,” for each of the compatibility questionnaire scales, which in this case is 16 (See Table 2 for examples including two of 16 scales). The number of scales in the present compatibility questionnaire is 16, however, as will be apparent to those skilled in the art, the number of scales on a questionnaire could be less than or greater than 16, and the number of scales is thus not limited to 16.

At this point, the user would have to join the internet dating service in order to be able to contact the users identified as “ideal matches.” In order to join the internet dating service, they would have to provide a user name and obtain a password to enter the site. They would then be able to enter traditional personal ad type information into a database that could be searched by other site members, including but not limited to personal photos and a narrative description. They would also be able to search other personal ads on the internet site. Contacts with other users would be initiated through double blind email.

Users would also be able to prioritize their searches by searching by a single content scale of the compatibility questionnaire, or by combining two or more content scales into a single search (See Table 3). The search results would present a percentile score for the combined scales. Percentile scores would also be reported for each of the content scales, but only for the users identified as the top ranked “ideal matches” for the combined scales (See Table 4).

A link would be provided on the internet site so that the user could conveniently link to the personal ad information of each of the “ideal matches.” This could be accomplished by a link in which the user types in the user names of the “ideal match” separately. The particular method of linking to “ideal matches” would not be limited to this methodology, however.

The methodology for accomplishing the tasks previously described will now be presented in detail. A relational database, such as MySQL, would be employed on a web server in order to maintain security of the database. A separate database file would be created to hold the database of questionnaire responses of all users' self descriptions. This database would be further defined by identifying information including but not limited to usemrname, age, gender, and educational level.

Another separate database file would be created to hold each member's completed “ideal match” questionnaires. Both database files would be maintained for an indefinite period of time in order to obtain norm group data. Norm group data would be used to report percentile scores to users for searches that utilize the entire compatibility questionnaire, as well as separate scales and combinations of scales from the questionnaire.

The method in which the computer program searches for an individual's “ideal match” will now be described. After completing the self description and description of his or her “ideal match,” the user defines a search by identifying the search parameters of his “ideal match,” based upon demographic information. The computer program would limit the search to questionnaires in the existing self description database that fall within the parameters of the user's “ideal match” search. The computer program would utilize Pearson correlation to identify the pattern of similarity in item responses between the “ideal match” description and each of the self description questionnaires identified by the search parameters.

The computer program would then assign percentile scores to the correlation coefficients of each of the “ideal match” questionnaires and sort the correlation coefficients from highest to lowest rank. A specified number of the top ranked questionnaires would then be compared to a database file that contains norm group information.

The percentile scores that would be reported to the user (See Table 1) would be obtained by the computer program comparing the top ranked “ideal match” correlation coefficients to a norm group of “ideal match” correlation coefficients. This would be accomplished in the following manner.

The norm group would consist of at least 1000 completed “ideal match” searches for each gender. In the preferred embodiment these searches would not be limited by any identifying or demographic information other than gender. The correlation coefficients from the 1000 searches for each gender would be assigned percentile scores. The correlation coefficients of the top “ideal matches” are paired with the corresponding correlation coefficients from the norm group, and the percentile scores from the norm group are reported to the user (See Table 5).

The reason for this is that if the percentile scores for the “ideal matches” that are reported to the user is obtained from smaller population of questionnaires from the search parameters defined by the user, the percentile scores would always start at 100 for the top ranked correlation. This would not provide useful information to the user regarding the degree of credibility to place in a given search. However, if the correlation coefficients of the top “ideal matches” are paired with the corresponding correlation coefficients from the norm group, and the percentile scores from the norm group are reported to the user, it would provide a more accurate measure with which to judge the credibility of a given search. A correlation, for example of 0.68, of the top ranked “ideal match” would always be at the 100^{th} percentile if limited to the search parameter sample. However, when compared to the norm group sample it may only be at the 55^{th} percentile (See Table 5).

A similar methodology would be employed to obtain the percentile scores for each scale and all possible combinations of scales. That is, norm groups for each gender would be obtained that define the percentile ranks for the correlation coefficients of 1000 individuals initially for each of the 16 scales and each possible combination of scales. The preferred embodiment would not limit the searches for the “ideal match” by identifying or demographic data.

Norm group data that consists of correlation coefficients and corresponding percentiles for the entire compatibility questionnaire, each scale and all possible combinations of scales for each gender would be retained and added to as new members are added to the dating service. The norm group information would be updated periodically in order to report percentile information to users that is most accurate.

The invention has been shown and described with reference to the preferred embodiments thereof. However, it will be understood by those skilled in the art that various changes in form and details may be made therein without departing from the spirt and scope of the invention. The present invention should only be limited by the following claims and their legal equivalents.

TABLE 1
Compatible Lifestyle Questionnaire
“Ideal Match” Search Results

| | Percentile in this | |
|---|---|---|
| | search of 143 women | Percentile of 1000 |
| User name | ages 18-25 | women ages 18+ |
| SheilaW | 100 | 58 |
| Ashley12 | 99 | 57 |
| Morganza | 98 | 56 |
| Lotusblossom | 97 | 55 |
| KathyP | 96 | 53 |

TABLE 2
“Ideal Match” Search Results

| | | |
|---|---|---|
| | Percentile in this | |
| | search of 143 women | Percentile of 1000 |
| User name | ages 18-25 | women ages 18+ |

Romantic Style

| | | |
|---|---|---|
| Morganza | 100 | 78 |
| Lotusblossom | 99 | 74 |
| KathyP | 98 | 70 |
| Sheila W | 97 | 68 |
| Ashley12 | 96 | 65 |

Personality

| | | |
|---|---|---|
| Sheila W | 100 | 88 |
| KathyP | 99 | 86 |
| Morganza | 98 | 84 |
| Ashley12 | 97 | 80 |
| Lotusblossom | 98 | 77 |

TABLE 3
Combined Communication and Conflict Resolution Style
“Ideal Match” Search Results

| | Percentile in this | |
|---|---|---|
| | search of 98 men | Percentile of 1000 |
| User name | ages 32-40 | men ages 18+ |
| HenryO | 100 | 88 |
| Jack32 | 99 | 84 |
| Highroller1 | 98 | 79 |
| Kosta | 97 | 66 |
| Southernman | 96 | 65 |

TABLE 4
“Ideal Match” Search Results

| | | |
|---|---|---|
| | Percentile in this | |
| | search of 98 men | Percentile of 1000 |
| User name | ages 32-40 | men ages 18+ |

Communication Style

| | | |
|---|---|---|
| Jack32 | 100 | 78 |
| Kosta | 99 | 75 |
| Sourthernman | 98 | 72 |
| Highroller1 | 97 | 66 |
| HenryO | 96 | 64 |

Conflict Resolution Style

| | | |
|---|---|---|
| Kosta | 100 | 55 |
| Highroller1 | 99 | 51 |
| Jack32 | 98 | 45 |
| HenryO | 97 | 43 |
| Sourthernman | 96 | 41 |

TABLE 5
Correlation Norm Group Study

| | | Percentile scores |
|---|---|---|
| Correlation | | of top five ranked |
| coefficient | Percentile scores | “ideal matches” |
| of top five ranked | of top ranked | correlation coefficients |
| “ideal matches | “ideal matches” | obtained from |
| for small sample | for small sample | norm group of 1000 |
| defined by user | defined by user | “ideal match” |
| search parameters | search parameters | correlation coefficients |
| .68 | 100 | 55 |
| .65 | 98 | 54 |
| .64 | 97 | 53 |
| .63 | 96 | 51 |
| .60 | 95 | 47 |

1) A unique method for determining compatibility between people, which in its preferred embodiment is employed on an interactive internet dating site.
a) A questionnaire whose items pertain to compatibility.
b) The questionnaire contains items that reflect the degree to which one agrees that a questionnaire item describes oneself, ranging from two extremes, such as “not at all” to “very,” or “strongly disagree” to “strongly agree,” and reflect the degree of similarity as well as the degree of differences in compatibility.
c) Separate scales within the questionnaire that contain different content areas that pertain to compatibility.

2) A method to determine compatibility based upon similarity of pattern responses between a pool self descriptions and the user's “ideal match” description on the compatibility questionnaire.
a) A method for the individual user to describe one's own self and one's “ideal match”
b) A method to define search parameters.
c) A statistical method to obtain the highest degree of similarity between one's “ideal match” and the choices available from the pool of self descriptions defined by the search parameters.

3) A method for the user to complete a compatibility search utilizing a single content scale or combinations of scales from a compatibility questionnaire

4) A method to report to the user the highest ranked compatibility matches utilizing percentile scores that are derived from a norm group of correlation coefficients
